(19) United States
(12) Patent Application Publication
(10) Pub. No.: US 2007/0171818 A1
(43) Pub. Date: Jul. 26, 2007

(54) Wireless access method and system

(76) Inventors: Yozo Shoji, Tokyo (JP); Hiroyo Ogawa, Tokyo (JP)

Correspondence Address: MCGLEW & TUTTLE, PC, P.O. BOX 9227, SCARBOROUGH STATION, SCARBOROUGH, NY, 10510-9227, US

(21) Appl. No.: 10/597,694

(22) PCT Filed: Feb. 25, 2004
(86) PCT No.: PCT/JP04/02204

§ 371 Date: Aug. 3, 2006

(51) Int. Cl. H04L 12/26; H04Q 7/00

(52) U.S. Cl. 370/229; 370/328

(57) ABSTRACT

A system shown in the drawing automatically sends information stored in a server to a mobile terminal (MT) that has entered a service area. At least one access point station (AP#1) of access point stations (AP#1 to AP#3) installed in a high place is connected by cable to a contents server or an external network; a service area having a shape of a spot is deployed under the above access point station. Further, the access point station (AP#1) is linked wirelessly ad hoc to another access point station (AP#2, AP#3) by means of wireless P-P (point-to-point) link. Consequently, the another access point station can also deploy an equivalent hotspot service. Accordingly, a millimeter-wave ad hoc communication network spreading two-dimensionally can be realized without constructing a cable network.

### TECHNICAL FIELD

The present invention relates to a wireless access method and system in which there are installed a plurality of access point stations forming a communication link with a mobile wireless terminal which has entered a wireless service area, and a communication link is formed between the plurality of access point stations to perform communication.

### BACKGROUND ART

The present inventor has studied a millimeter-wave ad hoc wireless access system utilizing the broadband characteristics of millimeter-wave band and the propagation characteristics suitable for relatively short distance communication since 2001. In the millimeter-wave ad hoc wireless access system which the present inventor aims to develop, under an environment where a plurality of communicatable terminals are present in the neighborhood, a network is instantly and automatically constructed as required. For example, in a comparatively small meeting or the like, each participant can carry a note-type PC or the like with a wireless communication terminal function and share presentation documents of the presenters in real time. In millimeter-wave communication, broadband frequency can be used for communication. Therefore, materials etc. including high-quality moving images, can also be shared without any stress.

FIG. 9 shows a network configuration diagram based on conventional art. In the system shown in FIG. 9, there is shown an image of using a system which is supposed to be used in an exhibition site and automatically delivers information stored in a server to a mobile terminal (MT) which has entered a service area. There are installed a plurality of access point stations (AP#1 to AP#3) disposed in a high place, and under each access point station, there are deployed service areas (millimeter-wave hotspot access service zone #1 to #3) having a shape of a spot. All the access point stations are connected by cable to a contents server or an external network (IP network). Millimeter-wave band is narrow in service area, and therefore has an excellent characteristic that there is hardly any possibility of interfering with other communication. However, due to this characteristic, a plurality of access point stations must be installed to expand a service area.

In this manner, access point stations are connected by a cable network to expand a network, and an equivalent hotspot service is deployed under each access point station, whereby a millimeter-wave ad hoc communication network spreading two-dimensionally is realized.

However, in the above system of conventional art, each access point station (AP) must include a modulation/demodulation device (BB&IF: Baseband-IF device) and an access control device, thus resulting in a high cost.

Also, according to the present invention, as described later in detail, in order to allow an intermediate-frequency (IF) band signal processing without causing deterioration in frequency stability associated with frequency conversion, a self-heterodyne transceiver can be used. This self-heterodyne transceiver itself is known. The known self-heterodyne transceiver will be briefly described below.

FIG. 10 is a view illustrating a wireless communication apparatus described in Japanese Patent Laid-Open No. 2001-53640. In the transmitter shown in FIG. 10, an intermediate-frequency band modulating signal IF obtained by modulating an input signal is multiplied by a local oscillator signal LO from a local oscillator in a mixer to generate a radio modulating signal RF. This RF is passed through a filter to eliminate its unwanted components, and part of LO is added thereto in a power combining unit. Then its signal level is increased by an amplifier and subsequently the signal is transmitted as a radio signal via an antenna Tx. Meanwhile, in a receiver, the radio signal received via an antenna Rx is filtered by a filter included in the receiver after its signal level is increased by an amplifier, and then restored to IF by a square unit. In this technique, the same LO as that used to generate an RF signal is transmitted as a radio signal. Consequently, there is an advantage in that effects of phase noise of the local oscillator being the LO source are cancelled at the time of demodulation and that, demodulated IF is restored to the original IF frequency supplied to the transmitter.

The above technique is only related to a one-way wireless communication apparatus, but in actual communication, bi-directional communication is needed. Regarding a configuration in such a case, the present inventors have already proposed “bi-directional wireless communication system and bi-directional wireless communication method” described in Japanese Patent Laid-Open No. 2002-9655.

### DISCLOSURE OF THE INVENTION

An object of the present invention is that when a plurality of access point stations deploying an equivalent hotspot service under each access point station are connected to expand a network, and a millimeter-wave ad hoc communication network spreading two-dimensionally is thereby realized, then each access point (AP) does not need to include a modulation/demodulation device and an access control device, and the network can be constructed and expanded only by wireless means, thus achieving cost reduction.

Another object of the present invention is to use a self-heterodyne transceiver and thereby allow an IF band signal processing without causing deterioration in frequency stability associated with frequency conversion.

According to the present invention, there are installed a plurality of access point stations deploying a wireless service area and forming a communication link with a mobile radio terminal which has entered the service area, and a communication link is formed between the plurality of access point stations. Each of the plurality of access point stations includes an RF transceiver used to form a point-to-multipoint type communication link with the mobile radio terminal and further includes one or more RF transceivers used to form a point-to-point type communication link with another access point station.

Accordingly, when constructing a hotspot type network constituted of access point stations and mobile radio terminals, the network can be constructed and expanded only by wireless means, thus achieving excellence in cost reduction and real-time nature.

One of the plurality of access point stations is a control access point station performing signal modulation/demodulation or access control, and the other access point stations are a repeater access point station. Upon receipt of a signal from an access point station other than the own station, the repeater access point station branches the signal into two signals, broadcasting and delivering one branched signal to all mobile radio terminals belonging to the coverage area of the own station and at the same time, relaying/transmitting the other branched signal to another repeater access point station based on a non-reproduction scheme. Upon receipt of a radio signal transmitted from a mobile radio terminal belonging to the coverage area of the own station, the repeater access point station relays/transmits this signal to another access point station based on a non-reproduction scheme. As described above, the repeater access point station used for network expansion does not need to include any modulation/demodulation function and access function, thus achieving cost reduction.

To a radio signal transmitted from the control access point station to another access point station, there is attached destination information for allowing a destination access point station to perform identification. Each repeater access point station identifies destination information of a received signal, relaying/transmitting the signal to another access point station based on a non-reproduction scheme when the signal is not destined for the own station, broadcasting the signal to the coverage area of the own station to deliver it to all mobile radio terminals when the signal is destined for the own station. The attaching of destination information allows a more effective use of network band, so improvement of throughput can be expected.

Signal processing at the access point station can be performed in IF frequency band obtained by performing down-converting from RF frequency band. In this case, as the RF transceiver included in the access point station, one based on a millimeter-wave self-heterodyne scheme can be used.

When signal processing is performed in IF band, the processings, such as signal detection and switching, are made easier. Further, when a self-heterodyne transceiver is used, IF band signal processing can be performed without causing any deterioration in frequency stability associated with frequency conversion.

### BRIEF DESCRIPTION OF THE DRAWINGS

FIG. 1 is a view illustrating a schematic whole system configuration of the present invention;

FIG. 2 is a diagram illustrating an external view of an access point station;

FIG. 3 is a view illustrating a first embodiment embodying the system illustrated in FIG. 1;

FIG. 4 is a view illustrating a configuration of the signal detection/distribution circuit shown in FIG. 3;

FIG. 5 is a view illustrating a second embodiment embodying the system illustrated in FIG. 1;

FIG. 6A is a view illustrating a repeating signal from another AP;

FIG. 6B is a view illustrating the signal detection/destination detection/switching circuit usable in the second embodiment shown in FIG. 5;

FIG. 7 is a view illustrating a third embodiment embodying the system illustrated in FIG. 1;

FIG. 8 is a view illustrating a fourth embodiment embodying the system illustrated in FIG. 1;

FIG. 9 is a view showing a network configuration based on conventional art; and

FIG. 10 is a view illustrating a wireless communication apparatus described in Japanese Patent Laid-Open No. 2001-53640.

### BEST MODE FOR CARRYING OUT THE INVENTION

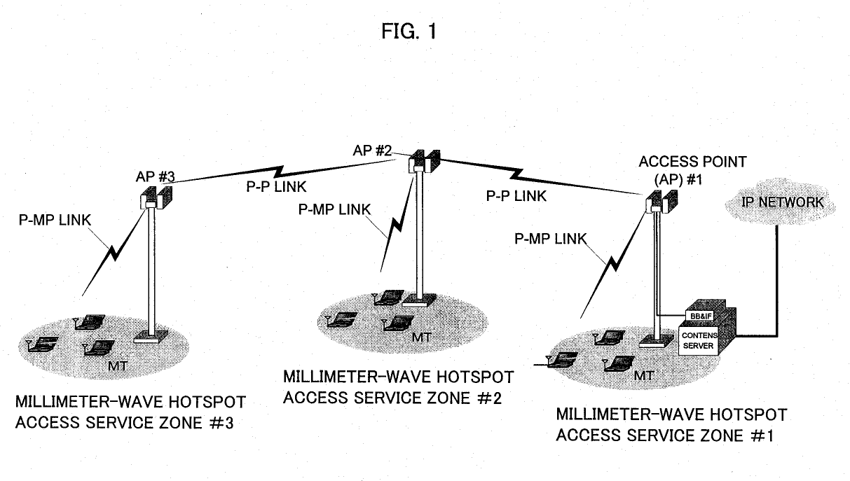

The present invention will be described below with reference to the illustrations. FIG. 1 is a view illustrating a schematic whole system configuration of the present invention. In the system shown in FIG. 1, there is shown an image of using a system which is supposed to be used in an exhibition site and automatically delivers information stored in a server to a mobile terminal (MT) which has entered a service area. Also, communication mode via an access point station installed in a high place as well as direct communication between mobile terminals is possible and further, application to between-road-and-vehicle communication, inter-vehicle communication, and the like in ITS regarding a road or the like as a sequence of RF zones is also possible.

At least one (AP#1 of FIG. 1) of a plurality of access point stations (in this illustration, three stations AP#1 to AP#3) installed in a high place is connected by cable to a contents server or an external network. Under this access point station, there is deployed a service area having a shape of a spot. Further, this access point station (AP#1) is linked wirelessly ad hoc to another access point station (AP#2, AP#3) by means of wireless P-P (point-to-point) link. Consequently, the another access point station can also deploy an equivalent hotspot service. Accordingly, a millimeter-wave ad hoc communication network spreading two-dimensionally can be realized without constructing a cable network.

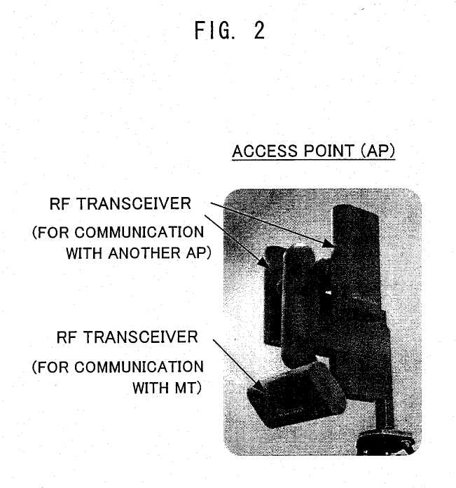

FIG. 2 is a diagram illustrating an external view of such access point station. Each access point station includes an RF transceiver for deploying a wireless service area under the location of placement of the own station and forming a P-MP (point-to-multipoint) type communication link with a mobile terminal MT which has entered the service area, and further includes one or more RF transceivers using a relatively narrower beam antenna for forming a P-P (point-to-point) type communication link with another access point station. According to the present invention, access point stations having such function are constructed/added in cascade arrangement or two-dimensionally across a wide area, whereby a wireless service zone is deployed on a planar surface.

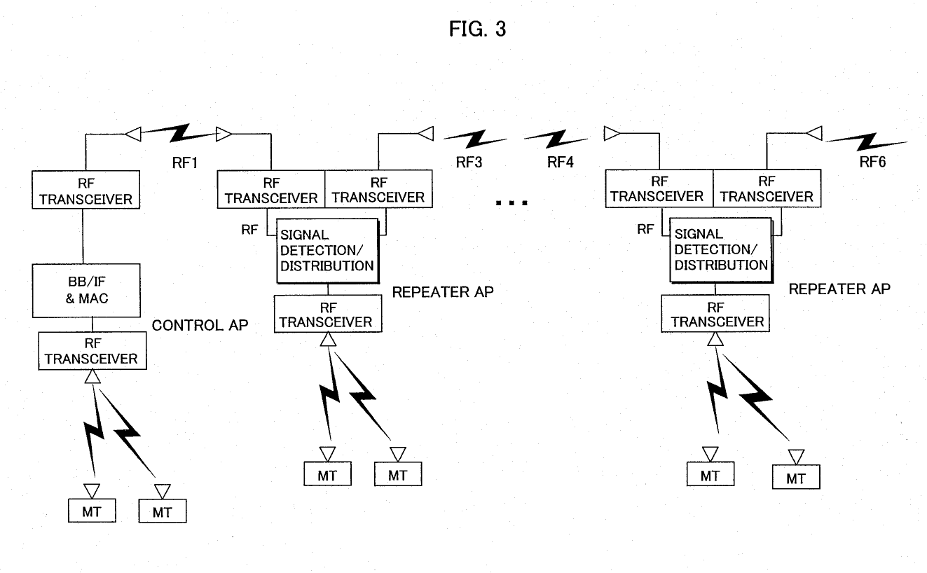

FIG. 3 is a view illustrating a first embodiment embodying the system illustrated in FIG. 1. One station (AP#1 illustrated in FIG. 1) of the plurality of access point stations is a control AP station including a signal modulation/demodulation device (BB&IF: Baseband-IF device) and an access control device (MAC: media access control). Therefore, as described with reference to FIG. 1, only this control AP station is connected by cable to a contents server or an external network.

In FIG. 3, a signal from the signal modulation/demodulation device and access control device (BB/IF&MAC) is branched into two signals. One of the two signals is broadcasted to the coverage area of the own station via an RF transceiver to be delivered to all mobile terminals MT, and a radio signal transmitted from any of the mobile terminals MT belonging to this coverage area is received. The other branched signal is transmitted to a repeater AP station having a P-P link formed via an RF transceiver.

Upon receipt of a signal from an access point station (including a control AP station) other than the own station, the repeater AP station divides the signal, and broadcasts one part of the signal to the coverage area of the own station to deliver it to all MTs, and relays/transmits, based on a non-reproduction scheme, the other part of the signal to a repeater AP station having another P-P link formed. Meanwhile, upon receipt of a radio signal transmitted from an MT belonging to the coverage area of the own station, the repeater AP station relays/transmits, based on a non-reproduction scheme, this signal to all the other AP stations having a P-P link formed. The term “non-reproduction scheme” as used in the present specification means a scheme of processing a signal in an RF frequency (RF) signal state or in a state obtained by performing frequency conversion to an intermediate frequency (IF) signal without performing demodulation to a base-band signal.

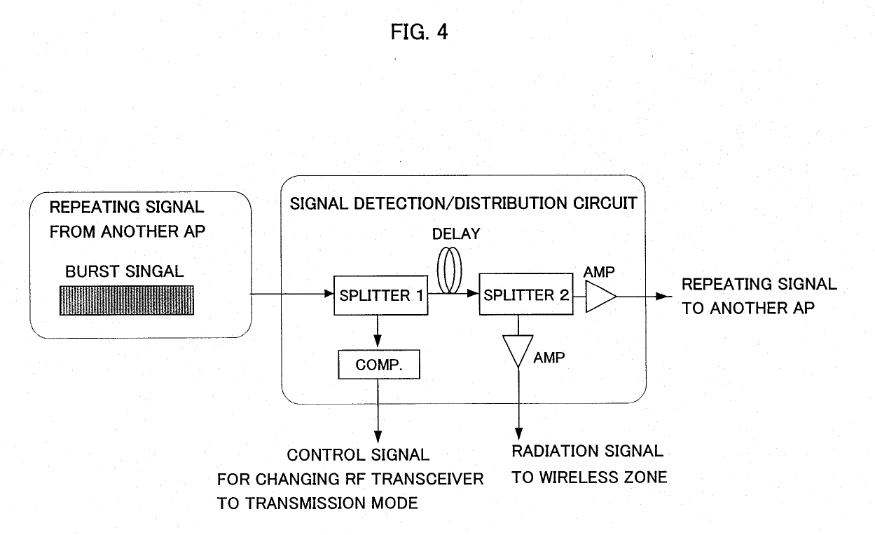

FIG. 4 is a view illustrating a configuration of the signal detection/distribution circuit shown in FIG. 3. To the signal detection/distribution circuit, there is supplied, via the RF transceiver shown in FIG. 3, a repeating signal composed of a burst signal from another access point station. In a first splitter (Splitter 1) of the signal detection/distribution circuit, a part of the burst signal proceeding to a second splitter (Splitter 2) via a delay circuit (Delay) is branched. In a comparator (Comp.), detected from part of the branched burst signal is a control signal for changing the RF transceiver to a transmission mode. When this control signal is detected, as described above with reference to FIG. 1, the burst signal branching out from the second splitter is broadcasted via an amplifier (Amp) from the RF transceiver to a mobile terminal MT which has entered the service area. Also, from this second splitter, a repeating signal is transmitted to another AP via an amplifier (Amp). The aforementioned delay circuit (Delay) serves to adjust the phase of a burst signal to be controlled to the phase of a control signal controlling the burst signal.

The circuit shown in FIG. 4 can be seen as a “one-input two-output circuit” distributing one radio signal as two radio signals. When such circuit is provided in all three ports of the signal detection/distribution circuit shown in FIG. 3, a radio signal supplied from any of the ports can be distributed to the other two ports.

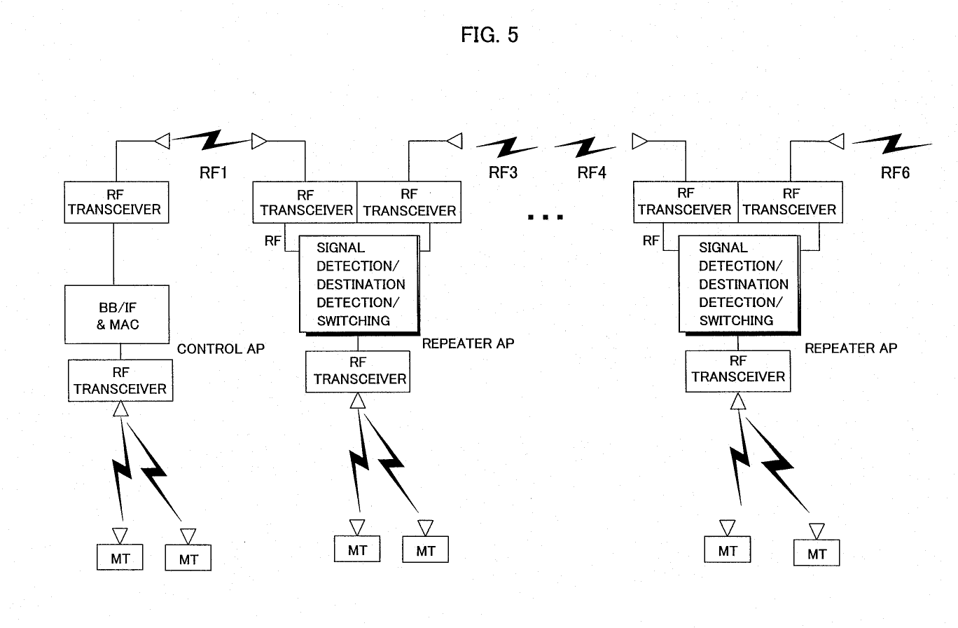

FIG. 5 is a view illustrating a second embodiment embodying the system illustrated in FIG. 1. Similarly to the first embodiment, a control AP station broadcasts a radio signal to the coverage area of the own station to deliver it to all MTs and at the same time, transmits it to a neighboring repeater AP station. At this time, according to the second embodiment, destination information is attached to the radio signal. A repeater AP station receiving this radio signal identifies destination information of the signal received from the control AP station, relaying/transmitting the radio signal as it is to another AP station based on a non-reproduction scheme when the signal is not destined for the own station, broadcasting the signal to the coverage area of the own station to deliver it to all MTs when the signal is destined for the own station. The another AP station receiving a repeating signal also operates similarly.

To a radio signal transmitted by a mobile terminal MT, there is attached destination information indicating a destination AP station, or destination information indicating that the signal is destined for a control AP station. In the former case, firstly, the repeater AP station receiving this signal transmits it to a neighboring repeater AP station or a control AP station without performing demodulation. As with downlink operation, a repeater AP station receiving a radio signal from another repeater AP station determines, according to destination of the received radio signal, whether or not the signal is destined for the own station, radiating it to the wireless zone of the own station based on a non-reproduction scheme when the signal is destined for the own station, transmitting it to a subsequent repeater AP station or a control AP station when the signal is not destined for the own station. In the latter case, the signal is unconditionally transferred toward a control AP station based on a non-reproduction repeating scheme.

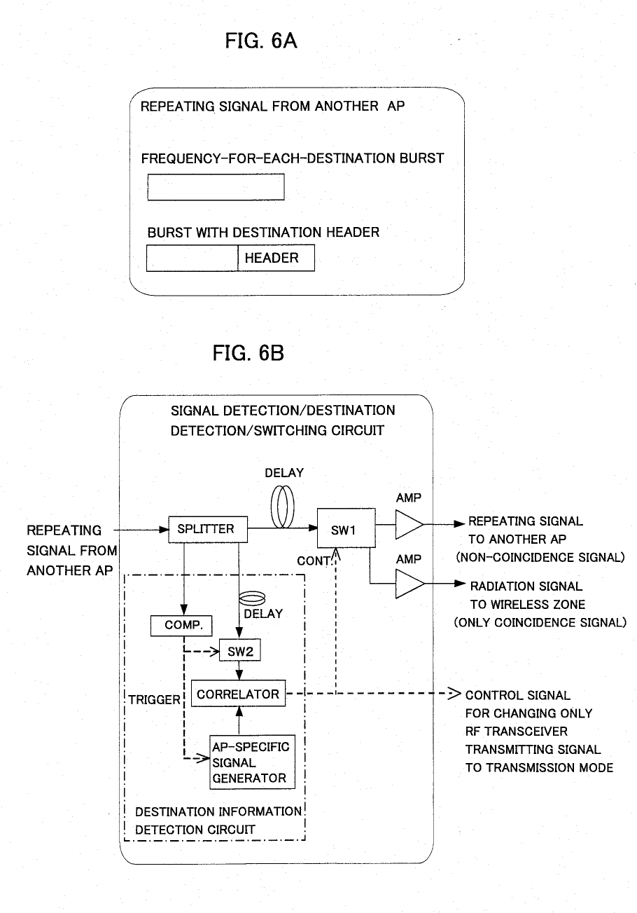

FIG. 6A is a view illustrating a repeating signal from another AP. FIG. 6B is a view illustrating the signal detection/destination detection/switching circuit usable in the second embodiment shown in FIG. 5. In order for each AP station to identify destination information of a received radio signal to determine whether or not the signal is destined for the own station, for example as shown in FIG. 6A, a different frequency to be identified can be allocated as the burst signal RF frequency, or header information can be attached to the burst signal to be transmitted.

To the signal detection/destination detection/switching circuit, there is introduced a repeating signal from another AP via an RF transceiver (FIG. 5). A radio signal passing through a Splitter shown in FIG. 6B is transmitted, as a repeating signal to be sent to another AP or as a radiation signal toward the wireless zone of the own station, via a delay circuit (Delay), a switch (SW1) and an amplifier (Amp).

Meanwhile, the repeating signal (the input signal to the signal detection/destination detection/switching circuit) from another AP is branched out from the Splitter to a destination information detection circuit and in this circuit, it is determined whether or not the signal is destined for the own station. In the destination information detection circuit illustrated in FIG. 6B, there is illustrated a circuit which detects header information when the header information is attached to a burst signal and transmitted.

In a comparator (Comp.), it is detected whether the level of the radio signal branching out from the Splitter is greater than a predetermined level or not; if greater than the predetermined level (i.e., when a burst signal is detected), a switch (SW2) and an AP-specific signal generator are triggered. At this time, the branching burst signal is introduced to a first input of a correlator via SW2 and at the same time, to a second input of the correlator, there is introduced an output from the AP-specific signal generator. The correlator calculates whether or not these two inputs coincide with each other; if so, it is determined that the repeating signal from another AP is destined for the own station, and then the switch SW1 is controlled to send a radiation signal to the wireless zone. If these two inputs don't coincide with each other, i.e., if it is not determined that the repeating signal is destined for the own station, then the signal is transmitted as a repeating signal to another AP. The control signal from the correlator not only controls the switch SW1 but also is transferred as a signal for controlling the RF transceiver itself to change only an RF transceiver which should transmit a signal, to a transmission mode.

The circuit shown in FIG. 6B can be seen as a “one-input two-output circuit” switching/outputting one radio signal as any of two radio signals. When such circuit is provided in all three ports of the signal detection/destination detection/switching circuit shown in FIG. 5, a radio signal inputted from any of the ports can be switched/outputted to the other two ports.

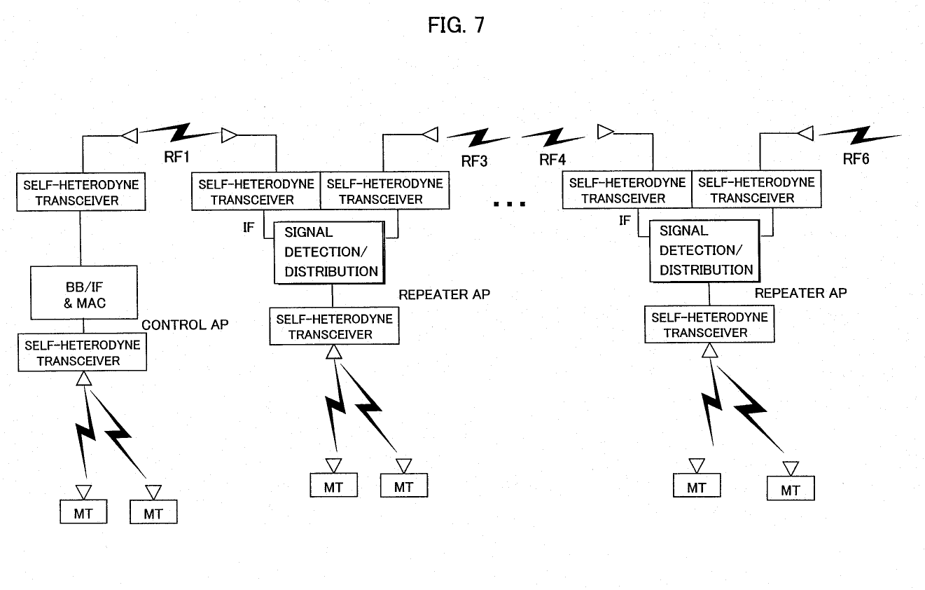

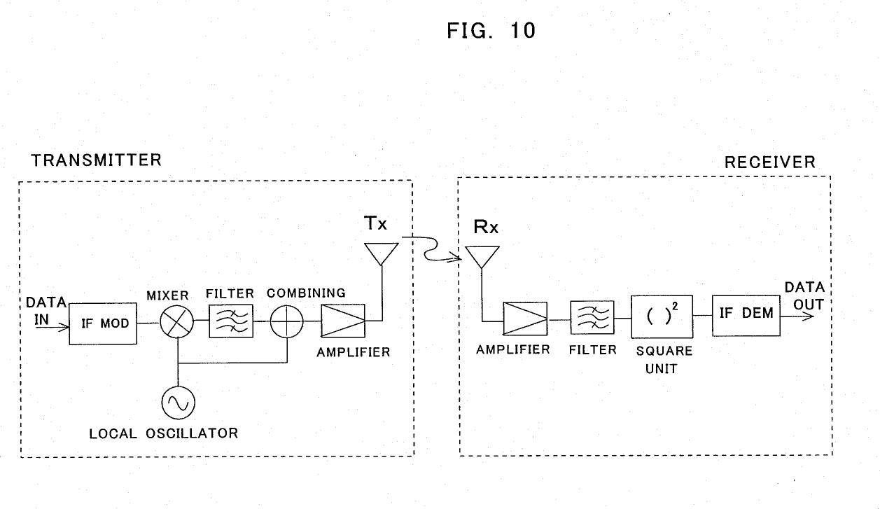

FIG. 7 is a view illustrating a third embodiment embodying the system illustrated in FIG. 1. The only difference from the first embodiment shown in FIG. 3 lies in that Self-heterodyne Transceiver is used as the RF transceiver. The Self-heterodyne Transceiver itself is known as described above with reference to FIG. 10. When such Self-heterodyne Transceiver is used, in principle, a signal processing can be performed in IF band without causing deterioration in frequency stability associated with frequency conversion. More specifically, even when frequency conversion to a different RF frequency is repeated many times to perform non-reproduction relaying, no deterioration in frequency stability occurs. When signal processing is performed in IF band in this manner, the processings such as signal detection and switching are made easier.

Upon receipt of a signal from another access point station (including a control AP station), a general access point station (repeater AP station) converts the radio signal to IF band. This IF band signal is branched, and one part is broadcasted to the coverage area of the own station at RF frequency via a self-heterodyne transceiver to be delivered to all MTs, and the other branched signal is directly sent as an IF band signal to a self-heterodyne transceiver based on a non-reproduction scheme, and then transmitted from the transceiver to another repeater AP station at RF frequency. When broadcasted to the coverage area of the own station, and when relayed/transmitted to another repeater AP station, frequency conversion into an arbitrary RF frequency is performed. As evident from the above description with reference to FIG. 10, in a self-heterodyne transceiver, part of a local oscillator signal is added to a radio signal to be transmitted, so even when frequency conversion to a different RF frequency is repeated many times, no deterioration in frequency stability occurs. An RF frequency broadcasted or relayed/transmitted may be the same as or different from the received RF frequency, but when a different frequency is used, there occurs an advantage in that interference between each of the wireless communication is reduced.

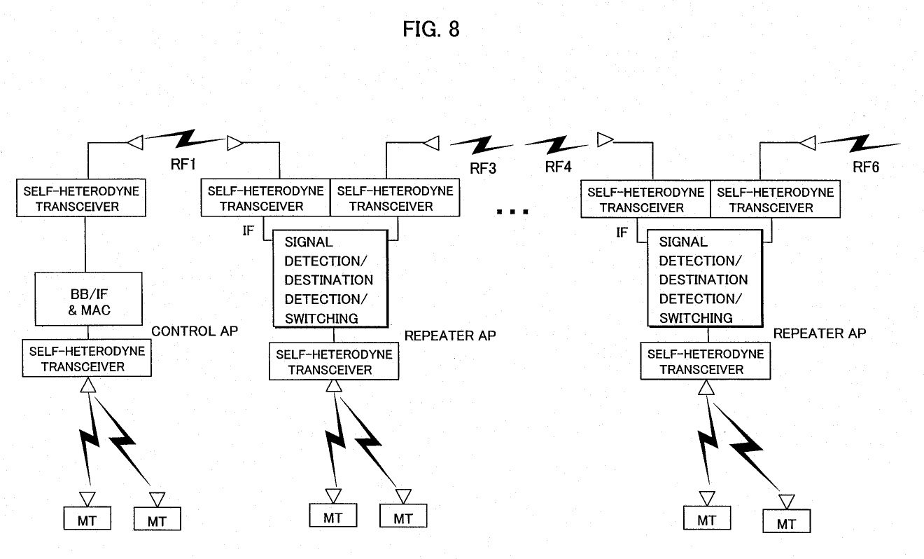

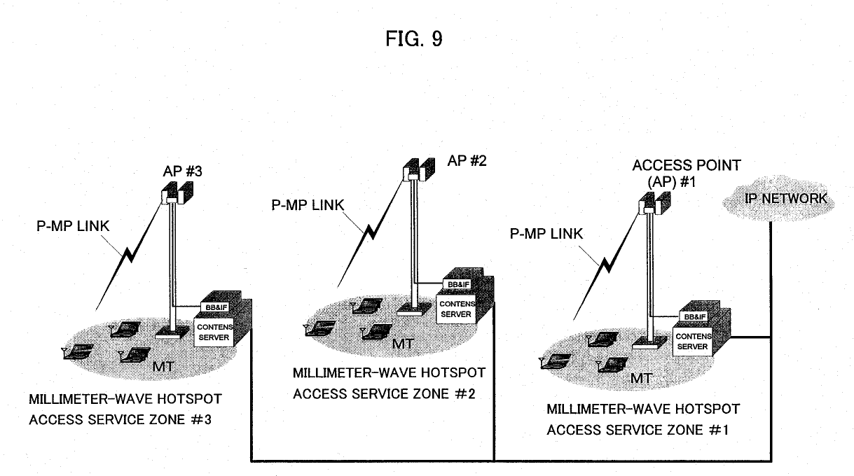

FIG. 8 is a view illustrating a fourth embodiment embodying the system illustrated in FIG. 1. The only difference from the second embodiment shown in FIG. 5 lies in that Self-heterodyne Transceiver is used as the RF transceiver. This embodiment is characterized in that signal detection and destination detection in AP station is performed not in RF band but after once down-converted to IF frequency band.

Each repeater AP station identifies destination information of a received signal, relaying/transmitting the signal to another AP station based on a non-reproduction scheme when the signal is not destined for the own station, broadcasting the signal to the coverage area of the own station to deliver it to all MTs when the signal is destined for the own station. In each AP station, in order to identify destination information of a received radio signal to determine whether or not the signal is destined for the own station, the radio signal is converted to IF band. When broadcasted to the coverage area of the own station after it is determined that the signal is destined for the own station, or when relayed/transmitted to another repeater AP station, frequency conversion into the same or a given different RF frequency is performed. After this, similarly to the third embodiment shown in FIG. 7, the radio signal is broadcasted or relayed/transmitted.

1. A wireless access method in which there are installed a plurality of access point stations deploying a wireless service area and forming a communication link with a mobile radio terminal which has entered the service area, and a communication link is formed between the plurality of access point stations to perform communication, the method comprising:
performing point-to-multipoint type communication with the mobile radio terminal by providing an RF transceiver in each of the plurality of access point stations; and
performing point-to-point type communication with other access point stations by providing one or more another RF transceivers in each of the plurality of access point stations.

2. The wireless access method according to claim 1, wherein:
one of the plurality of access point stations is a control access point station performing signal modulation/demodulation or access control, and the other access point stations are a repeater access point station;
upon receipt of a signal from an access point station other than the own station, the repeater access point station branches the signal into two signals, broadcasting and delivering one branched signal to all mobile radio terminals belonging to the coverage area of the own station and at the same time, relaying/transmitting the other branched signal to another repeater access point station based on a non-reproduction scheme; and
upon receipt of a radio signal transmitted from a mobile radio terminal belonging to the coverage area of the own station, the repeater access point station relays/transmits this signal to another access point station based on a non-reproduction scheme.

3. The wireless access method according to claim 2, wherein:
to a radio signal transmitted from the control access point station to another access point station, there is attached destination information for allowing a destination access point station to perform identification; and
each repeater access point station identifies destination information of a received signal, relaying/transmitting the signal to another access point station based on a non-reproduction scheme when the signal is not destined for the own station, broadcasting the signal to the coverage area of the own station to deliver the signal to all mobile radio terminals when the signal is destined for the own station.

4. The wireless access method according to claim 1, wherein signal processing at the access point station is performed in IF frequency band obtained by performing down-converting from RF frequency band.

5. The wireless access method according to claim 4, wherein the RF transceiver included in the access point station is based on a millimeter-wave self-heterodyne scheme.

6. A wireless access system in which there are installed a plurality of access point stations deploying a wireless service area and forming a communication link with a mobile radio terminal which has entered the service area, and a communication link is formed between the plurality of access point stations, the system comprising:
in each of the plurality of access point stations, an RF transceiver to form point-to-multipoint type communication link with the mobile radio terminal: and
one or more another RF transceivers to form a point-to-point type communication link with another access point station.

7. The wireless access system according to claim 6, wherein the plurality of access point stations are constructed in cascade arrangement or two-dimensionally across a wide area, whereby a wireless service zone is deployed on a planar surface.

8. The wireless access system according to claim 6, wherein:
one of the plurality of access point stations is a control access point station performing signal modulation/demodulation or access control, and the other access point stations are repeater access point stations;
upon receipt of a signal from an access point station other than the own station, the repeater access point station branches the signal into two signals, broadcasting and delivering one branched signal to all mobile radio terminals belonging to the coverage area of the own station and at the same time, relaying/transmitting the other branched signal to another repeater access point station based on a non-reproduction scheme; and
upon receipt of a radio signal transmitted from a mobile radio terminal belonging to the coverage area of the own station, the repeater access point station relays/transmits this signal to another access point station based on a non-reproduction scheme.

9. The wireless access system according to claim 8, wherein:
to a radio signal transmitted from the control access point station to another access point station, there is attached destination information for allowing a destination access point station to perform identification; and
each repeater access point station identifies destination information of a received signal, relaying/transmitting the signal to another access point station based on a non-reproduction scheme when the signal is not destined for the own station, broadcasting the signal to the coverage area of the own station to deliver the signal to all mobile radio terminals when the signal is destined for the own station.

10. The wireless access system according to claim 6, wherein signal processing at the access point station is performed in IF frequency band obtained by performing down-converting from RF frequency band.

11. The wireless access system according to claim 10, wherein the RF transceiver included in the access point station is based on a millimeter-wave self-heterodyne scheme.
